(19) United States
(12) Patent Application Publication
(10) Pub. No.: US 2004/0178734 A1
(43) Pub. Date: Sep. 16, 2004

(54) Fluorescent device, fluorescent lamp and glass composite

(76) Inventors: Yoshihisa Nagasaki, Osaka (JP); Shinya Hasegawa, Osaka (JP); Shiro Otake, Osaka (JP); Kazuhiro Morioka, Osaka (JP); Koichi Nakamura, Osaka (JP)

Correspondence Address: HARNESS, DICKEY & PIERCE, P.L.C., P.O. BOX 828, BLOOMFIELD HILLS, MI, 48303, US

(21) Appl. No.: 10/798,921

(22) Filed: Mar. 11, 2004

(30) Foreign Application Priority Data
Mar. 13, 2003 (JP) 2003-068016

(51) Int. Cl. H01J 1/62; H01J 63/04

(52) U.S. Cl. 313/634; 313/485; 313/486; 313/493; 313/635

(57) ABSTRACT

A fluorescent device contains a phosphor adhesive glass composite expressed by xSiO₂.yB₂O₃.aZnO.bAl₂O₃.cMgO.mXO, where X is at least one element selected from the group consisting of Ca, Sr and Ba, 5≦x≦70 mol %, 0≦y≦30 mol %, x+y≧20 mol %, and 5≦m≦60 mol %.

### BACKGROUND OF THE INVENTION

(1) Field of the Invention

The present invention relates to a fluorescent device, a fluorescent lamp and a glass composite.

(2) Description of Related Art

Fluorescent lamps are devices for emitting light outputs by converting ultraviolet light resulting from low pressure mercury vapor discharge in a glass bulb or tube into visible light and radiation light at a phosphor film coated inside the glass bulb or tube. The formation of a phosphor film typically uses a phosphor slurry obtained by dispersing phosphors, a phosphor adhesive glass composite, and a polymeric resin serving as a thickening agent into a dispersion medium such as butyl acetate or water. This slurry is applied to the inner surface of the glass bulb or tube and then dried to evaporate the dispersion medium that is a constituent of the slurry, and furthermore the thickening agent is decomposed and burned by baking so as to be removed. As a result, a phosphor film composed of the phosphors and the phosphor adhesive glass composite is formed.

Phosphor adhesive glass composites have the function of not only adhering phosphor particles together but also adhering the phosphor particles to the glass bulb or tube. This prevents the phosphor film from spalling away due to practically inevitable physical shocks such as vibrations during transport. Borate glass having a basic composition of BaO.CaO.B₂O₃ is typically used as phosphor adhesive glass composites for phosphor slurries using an organic solvent, such as butyl acetate, as a dispersion medium (see, for example, Japanese Examined Patent Publication No. 37-515).

On the other hand, for phosphor slurries using water as a dispersion medium, phosphor adhesive glass composites having the other compositions are used because borates dissolve in such slurries (see, for example, Japanese Unexamined Patent Publication No. 8-190896).

In three-band fluorescent lamps, phosphors used for a phosphor film are of three kinds: blue, green and red. Europium-activated yttrium oxide phosphor (Y₂O₃: Eu) is commonly used as a red phosphor. However, when this phosphor is used for daylight fluorescent lamps, their indices for feeling of contrast are not optimal (see, for example, Japanese Patent No. 3040719).

The index for feeling of contrast M represents an index of brightness sensation based on color rendering properties of a light source and is derived from the following equation:

M=[G(S, 1000(1×))/G(D₆₅, 1000(1×))]^{1.6}×100

wherein G(S, 1000(1×)) represents the area of the color gamut of four test colors under a sample light source S and an illuminance of 1000(1×), and G(D₆₅, 1000(1×)) represents the area of the color gamut of four test colors under a reference light source D₆₅ and a reference illuminance of 1000(1×).

The brightness sensation of a luminous environment is expressed by the product of its index for feeling of contrast and the luminous flux of the light source. Therefore, an improvement in the index for feeling of contrast allows the luminous environment to be perceived as brighter even under the same luminous flux of the light source. However, an excessively large index for feeling of contrast would cause a target object to be viewed in an unnatural color. Consequently, there exists the optimal range of indices for feeling of contrast that enhance the brightness sensation of the luminous environment and do not exhibit unnatural colors. This range depends on the correlated color temperature of illumination light.

A commonly used three-band daylight fluorescent lamp with a correlated color temperature of 7200K and a DUV of −3 has an approximately 100 index for feeling of contrast M. The optimal index for feeling of contrast at this correlated color temperature ranges from 111.9 to 139.9 both inclusive. Other commercially available daylight fluorescent lamps with the other correlated color temperatures also have indices for feeling of contrast falling below the optimal range.

An effective method for improving the index for feeling of contrast is to change the red phosphor from europium-activated yttrium oxide phosphor (Y₂O₃: Eu) having a maximum luminous peak of 611 nm to a deep red phosphor having a maximum luminous peak of 625 nm or more. In particular, europium-activated yttrium oxysulfide phosphor (Y₂O₂S: Eu) has a maximum luminous peak of 626 nm and a higher luminous efficacy than the other deep red phosphors in actual use such as manganese-activated germanate phosphor. Therefore, there can be provided a fluorescent lamp having the optimal index for feeling of contrast by using europium-activated yttrium oxysulfide phosphor as a red phosphor.

A fluorescent lamp manufacturing process includes thermal process steps, such as sealing, joining and tube bending requiring a temperature equal to or higher than the softening point of soda lime glass commonly used for fluorescent lamps (700° C. or higher). In such thermal process steps, oxidation of phosphor would provide deteriorated luminous characteristics of the phosphor itself. Thus, an inert gas, such as nitrogen, is encapsulated in a glass bulb or tube to prevent deterioration of phosphor characteristics due to the oxidation.

However, the present inventors found that a phosphor layer containing an oxysulfide phosphor such as europium-activated yttrium oxysulfide phosphor (Y₂O₂S: Eu) and a borate-base phosphor adhesive glass composite of BaO.CaO.B₂O₃ composition is colored in an inert gas atmosphere at a temperature of 700° C. or higher. Furthermore, they found that this initial coloration results from a chemical reaction between an inherently colorless borate-base phosphor adhesive glass composite and an oxysulfide phosphor. This coloration decreases the luminous efficacy of the whole phosphor layer. As can be seen from the above, the use of an oxysulfide phosphor provides optimized index for feeling of contrast but decreased initial total luminous flux. Therefore, it became obvious that the existing index-for-feeling-of-contrast improvement technique has substantially no effect of allowing the luminous environment to be perceived as bright.

### SUMMARY OF THE INVENTION

The present invention is made in view of the above-described problems, and an object thereof is to provide a fluorescent device that restrains a phosphor film from spalling away and being colored and has an improved chromaticity shift from the start. Furthermore, another object of the invention is to provide a fluorescent device that does not cause deterioration in luminous characteristics of a phosphor film in a fluorescent device manufacturing process using an oxysulfide phosphor such as Y₂O₂S:Eu and improves the index for feeling of contrast to have the effect of allowing a luminous environment to be perceived as bright.

A fluorescent device of the present invention comprises a phosphor adhesive glass composite and a phosphor, wherein the phosphor adhesive glass composite is expressed by xSiO₂.yB₂O₃.aZnO.bAl₂O₃.cMgO.MmO where X is at least one element selected from the group consisting of Ca, Sr and Ba, 5≦x≦70 mol %, 0≦y≦30 mol %, x+y≧20 mol %, 5≦m≦60 mol %, a<40 mol %, b≦10 mol %, c≦10 mol %, and a+b+c≧10 mol %.

The phosphor is preferably an oxysulfide phosphor.

In one preferred embodiment, 0≦y≦15 mol % and 6.5≦m≦60 mol %.

The oxysulfide phosphor is preferably europium activated yttrium oxysulfide phosphor.

In one preferred embodiment, the fluorescent device may further contain Tb³⁺ and 1≦Tb³⁺≦4 mol %.

A fluorescent lamp of the present invention comprises a phosphor adhesive glass composite and a phosphor, wherein the phosphor adhesive glass composite is expressed by xSiO₂.yB₂O₃.aZnO.bAl₂O₃.cMgO.mXO, wherein X is at least one element selected from the group consisting of Ca, Sr and Ba, 5≦x≦70 mol %, 0≦y≦30 mol %, x+y≧20 mol %, 5≦m≦60 mol %, a≦40 mol %, b≦10 mol %, c≦10 mol %, and a+b+c≧10 mol %. In this case, the phosphor may be an oxysulfide phosphor, and a discharge path may be nonlinear. A fluorescent lamp having a nonlinear discharge path has a fluorescent bulb or tube such as a ring-shaped tube, a U-tube, a spiral tube, a multi-tube having a bridge, and a C-tube and is obtained by heating a fluorescent bulb or tube to be bent and welded after the application of phosphor and a phosphor adhesive to the inner surface of the fluorescent bulb or tube.

In one preferred embodiment, 0≦y≦15 mol % and 6.5≦m≦60 mol %.

The oxysulfide phosphor is preferably europium activated yttrium oxysulfide phosphor.

The glass composite of the present invention is expressed by xSiO₂.yB₂O₃.aZnO.bAl₂O₃.cMgO.mXO where X is at least one element selected from the group consisting of Ca, Sr and Ba, 5≦x≦70 mol %, 0≦y≦30 mol %, x+y≧20 mol %, 5≦m≦60 mol %, a≦40 mol %, b≦10 mol %, c≦10 mol %, and a+b+c≧10 mol %.

### BRIEF DESCRIPTION OF THE DRAWINGS

FIG. 1 is a graph showing the relationship between the B₂O₃ and ZnO+Al₂O₃+MgO contents of phosphor adhesive glass composites and the values of coloration tests.

FIG. 2 is a graph showing the relationship between the amount of added Tb and relative luminance value in a sixth embodiment.

FIG. 3 is a graph showing the relationship between the B₂O₃ content of a phosphor adhesive glass composite and the initial total luminous flux of a fluorescent lamp.

FIG. 4 is a graph showing burning hours and chromaticity shift under the use of europium-activated yttrium oxide phosphor as a red phosphor and a composite of Example 3 or a known composite as a phosphor adhesive.

FIG. 5 is a graph showing burning hours and chromaticity shift of fluorescent lamps C and E of a seventh embodiment.

FIG. 6 is a table showing the characteristics of phosphor adhesive glass composites according to a first embodiment.

FIG. 7 is a table showing the characteristics of the other phosphor adhesive glass composites according to the first embodiment.

FIG. 8 is a table showing the characteristics of phosphor adhesive glass composites according to a second embodiment.

FIG. 9 is a table showing the characteristics of phosphor adhesive glass composites according to a third embodiment.

FIG. 10 is a table showing the characteristics of phosphor adhesive glass composites according to a fourth embodiment.

FIG. 11 is a table showing the characteristics of phosphor adhesive glass composites according to a fifth embodiment.

FIG. 12 is a table showing the characteristics of phosphor adhesive glass composites according to the sixth embodiment.

FIG. 13 is a table showing the characteristics of phosphor adhesive glass composites of comparative examples according to the sixth embodiment.

FIG. 14 is a table showing the characteristics of the other phosphor adhesive glass composites according to the sixth embodiment.

FIG. 15 is a table showing the characteristics of fluorescent lamps according to a seventh embodiment.

FIG. 16 is a table showing the characteristics of phosphor adhesive glass composites according to an eighth embodiment.

### DETAILED DESCRIPTION OF THE INVENTION

Typically, a fluorescent lamp manufacturing process includes thermal process steps, such as sealing, joining and tube bending, each requiring a temperature equal to or higher than the softening point of soda lime glass commonly used for fluorescent lamps (700° C. or higher), as well as baking requiring a temperature of about 400° C. through 550° C. A baking process step is for decomposing and burning a thickening agent to remove it. If the glass transition temperature of a phosphor adhesive glass composite is lower than 550° C., this phosphor adhesive glass composite is softened in the baking process step. Therefore, the thickening agent cannot completely be decomposed and burned to remove it. This adversely affects the luminous flux and the lumen maintenance factor of a fluorescent lamp. On the other hand, if the glass transition temperature of the phosphor adhesive glass composite is 700° C. or higher, the phosphor adhesive glass composite is not softened even in a glass processing process step such as tube bending. Therefore, the effects of adhering the phosphor particles together and adhering the phosphor particles to a glass bulb or tube are not obtained, resulting in a phosphor film spalling away during glass processing.

In view of the above, it is preferable that the glass transition temperatures of phosphor adhesive glass composites according to embodiments of the present invention fall within a temperature range of 550 through 700° C. The phosphor adhesive glass composites are expressed by xSiO₂.yB₂O₃.aZnO.bAl₂O₃.cMgO.mXO, where X is at least one element selected from the group consisting of Ca, Sr and Ba, 5≦x≦70 mol %, 0≦y≦30 mol %, x+y>20 mol % and 5≦m≦60 mol %. A glass composite with this composition will be amorphous with stability while having the glass transition temperature falling within the above-described temperature range. The reason why the glass composite range is limited as described above will be described in detail in the below-mentioned embodiments.

A mixture of an oxysulfide phosphor and a phosphor adhesive glass composite produced in a high-temperature inert gas is colored by a solid-solution reaction between its phosphor component and the phosphor adhesive glass composite. Typically, oxysulfide phosphors have a lower pyrolysis temperature than oxide phosphors used for fluorescent lamps. Hence, oxysulfide phosphors more easily cause solid solution of its phosphor component in a phosphor adhesive glass composite and the subsequent reaction than oxide phosphors. The present inventors found compositions for glass composites that will not cause coloration due to the solid-solution reaction, on the basis of the prototyping and evaluation experiments of low-melting glasses of various types. Accordingly, the compositions for phosphor adhesive glass composites according to embodiments of the present invention are particularly significant if an oxysulfide phosphor is used as a phosphor. Particularly, when the oxysulfide phosphor is europium-activated yttrium oxysulfide phosphor, illumination light of a fluorescent lamp can be expected to have an improved luminous flux by preventing the phosphor adhesive glass composite from coloring and have an improved index for feeling of contrast.

The composition range of the glass composites according to embodiments of the present invention was determined on the basis of the following three items (stability, glass transition temperature and coloration test).

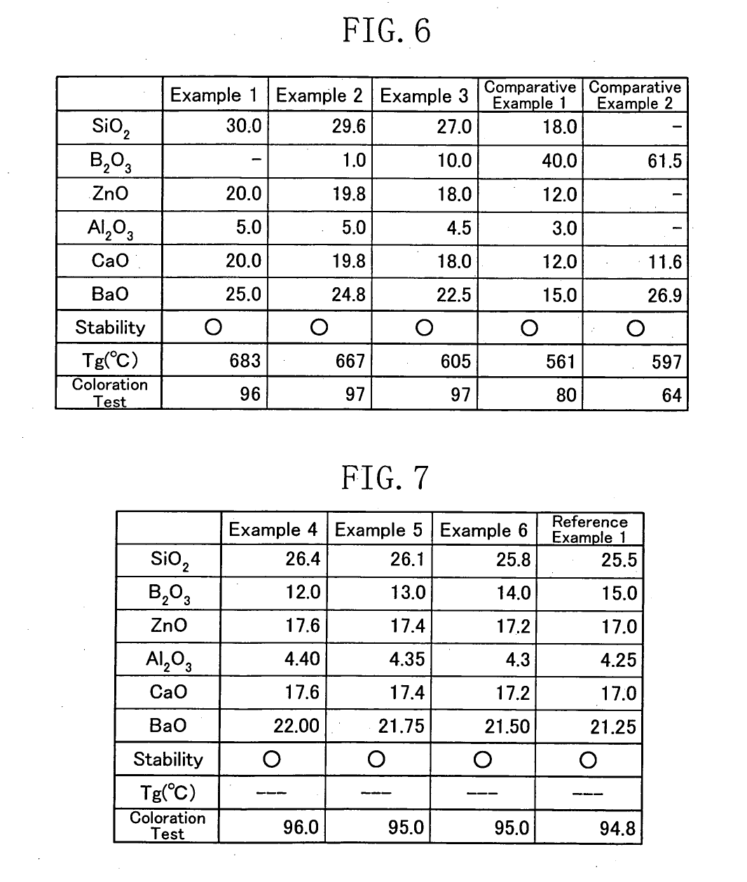

1. Stability: In order to prepare a phosphor adhesive glass composite of the present invention, oxide, and carbonate, oxalate, hydroxide and the like changed into oxide by heat treatment at a temperature of 1000° C. or higher, which are materials, are mixed at a stoichiometry that can provide a target composition. The resultant mixture is put in a heat-resistant vessel such as a platinum crucible, and melted by heating at temperatures at which the materials sufficiently melt (normally, 1000 through 1500° C.). Then, the melted mixture is rapidly cooled using a twin roller or the like. At this time, if the composition has a stable glass (amorphous) state, a completely transparent composite can be obtained. However, if the composition has an unstable glass state, a partly devitrified composite can be obtained. In the case of a fully invitrifiable composition, a completely devitrified and crystallized composite can be obtained. In FIGS. 6 through 16, completely amorphous composites, partly devitrified composites and completely devitrified composites are labeled “∘”, “Δ” and “×”, respectively, in terms of stability.

2. Glass transition temperature: The glass transition temperature (Tg) of a glass composite was measured using alumina as a reference sample by a differential thermal analysis method for analyzing a glass composite sample at a temperature rising rate of 10.0° C. per minute. As described above, in consideration of a process for manufacturing a fluorescent lamp, it is preferable that the glass transition temperature of a phosphor adhesive glass composite is 550 through 700° C.

3. Coloration test: In a glass composite coloration test, a phosphor adhesive glass composite was blended at 5% by weight of and into europium-activated yttrium oxysulfide phosphor, and the resultant mixture was heated at 800° C. for five minutes in a nitrogen atmosphere, and then measured in luminance by its excitation resulting from 254 nm ultraviolet radiation. The results of the coloration test are represented by relative luminance values obtained by blending, instead of a glass composite, alumina as a reference material into europium-activated yttrium oxysulfide phosphor and setting the luminance of the phosphor subjected to the same process at 100. The larger the coloration degree of the phosphor adhesive glass composite, the smaller the relative luminance value becomes. The reason for this is that part of light emitted by the phosphor is absorbed into the colored phosphor adhesive glass composite. It is determined that if the relative luminance value is 95 or more, the luminous flux of the fluorescent lamp can sufficiently be prevented from decreasing. Furthermore, a relative luminance value of 90 or more causes practically no problem even when it is smaller than 95.

Embodiments of the present invention will be described hereinafter with the drawings. In FIGS. 6 through 16, the content of each component is indicated in mol %.

### EMBODIMENT 1

The effects of B₂O₃ content in a phosphor adhesive glass composite of the present invention will be described hereinafter. FIG. 6 shows the compositions and evaluation results of phosphor adhesive glass composites of Examples 1 through 3 and Comparative Examples 1 and 2.

For a phosphor adhesive glass composite of Example 1, SiO₂, ZnO, Al(OH)₃, CaCO₃ and BaCO₃ were measured as starting materials such that the molar percentages of SiO₂, ZnO, Al₂O₃, CaO, and BaO in the glass composite were 30%, 20%, 5%, 20%, and 25%, respectively and then sufficiently mixed in a mortar. Thereafter, the mixed materials were put into a platinum crucible, and melted by heating at 1500° C. for 80 minutes. The resultant was poured onto a twin roller to rapidly cool it. The resultant composite was completely amorphous glass. It was broken to have a particle diameter of approximately 1 μm through coarse grinding with a mortar, pulverizing with a ball mill, and sifting.

The glass transition temperature of Example 1 obtained through the above process was 683° C., which falls within the temperature range suitable for a glass composite used for a fluorescent lamp. In this case, the value of a coloration test was 96, which shows that the luminous flux of a fluorescent lamp can sufficiently be prevented from decreasing.

Methods for preparing glass composites of the below-mentioned examples and comparative examples were carried out as described above. More particularly, materials including oxide, hydroxide and carbonate were measured and mixed to provide a desired composition. The mixed materials were melted at 1000 through 1500° C. and then rapidly cooled, thereby preparing a glass composite. This glass composite was grinded and sifted. A method for preparing a phosphor adhesive glass composite of the present invention is not limited to the above method. A desired composite can also be obtained, for example, using a wet method such as coprecipitation or Sol-gel processing.

As obvious from FIG. 6, glass transition temperatures of Examples 2 and 3 both fell within the temperature range suitable for a process for manufacturing a fluorescent lamp, and the values of coloration tests thereon exceeded 95. Thus, the glass composites of Examples 2 and 3 are effective for phosphor adhesion.

Comparative Example 2 is a BaO—CaO—B₂O₃ glass composite commonly used for a fluorescent lamp. Glass transition temperatures of Comparative Examples 1 and 2 were 561° C. and 597° C., respectively, which both fell within the temperature range suitable for a glass composite used for a fluorescent lamp. However, the values of coloration tests on Comparative Examples 1 and 2 were 80 and 64, respectively. Therefore, when Comparative Example 1 or 2 is used as a phosphor adhesive glass composite of a fluorescent lamp using an oxysulfide phosphor, coloration is caused in the phosphor film to decrease the luminous flux of the fluorescent lamp.

Conventionally, selected compositions of phosphor adhesive glass composites are compositions containing a large amount of B₂O₃ lowering the glass melting point in order to sufficiently soften glass in a heat treatment process step of lamp manufacturing. However, comparison between Examples 1 through 3 and Comparative Examples 1 and 2 has shown that the mol percentage of the constituent B₂O₃ needs to be at least less than 40% to restrain a glass composite from coloring during a process for manufacturing a lamp.

The coloration of fluorescent lamps using an oxysulfide phosphor was empirically studied in more detail on the amount of added B₂O₃. FIG. 7 shows the compositions of phosphor adhesive glass composites of this embodiment prepared for this experiment, their stabilities, and their degrees of coloration resulting from heating together with an yttrium oxysulfide phosphor. Examples of this embodiment correspond to Examples 4 through 6 and a reference for comparison is shown as Reference Example 1.

As seen from FIG. 7, a B₂O₃ content of 15 mol % or less allows the values of coloration tests to be 95 or more (also see the other embodiments). Therefore, the B₂O₃ content is preferably less than 15 mol %.

### EMBODIMENT 2

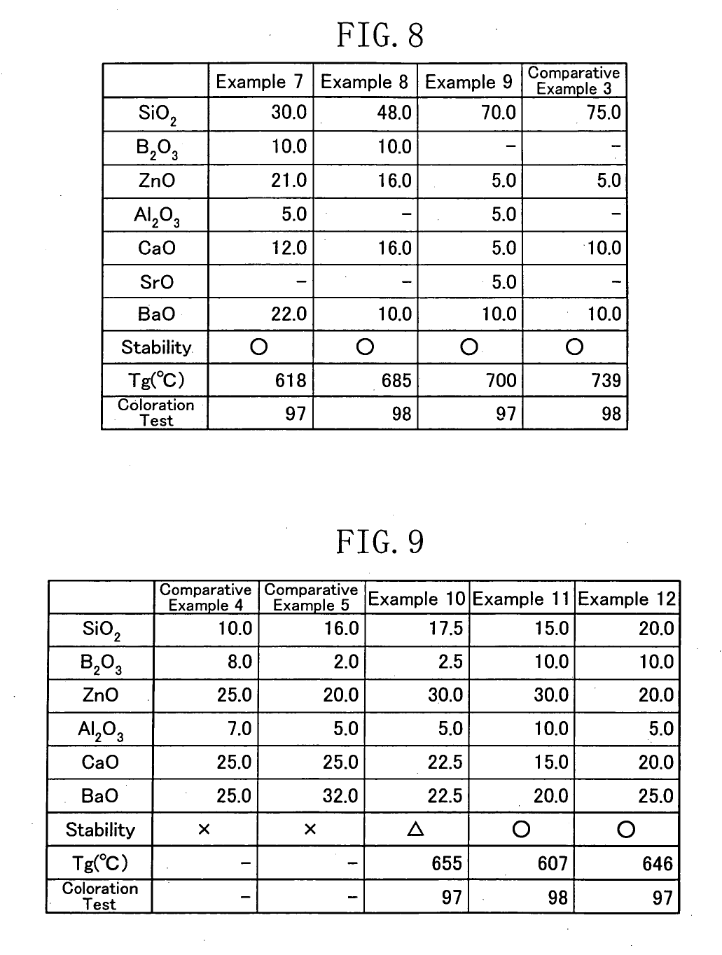

An effect of a SiO₂ content in a phosphor adhesive glass composite of the present invention will be described hereinafter. FIG. 8 shows the compositions and evaluation results of phosphor adhesive glass composites of Examples 7 through 9 and Comparative Example 3.

As obvious from FIG. 8, all of glass transition temperatures of Examples 7 through 9 fell within the temperature range suitable for a process for manufacturing a fluorescent lamp, and the values of coloration tests thereon exceeded 95. Thus, the glass composites of Examples 7 through 9 are effective for phosphor adhesion.

The glass transition temperature of Comparative Example 3 is 739° C. so that the glass composite is not softened even in a glass processing process step such as tube bending. Therefore, this glass composite is not effective for phosphor adhesion.

SiO₂ is a glass-forming oxide and is preferably contained in the glass composite to obtain a stable glass composite. However, since it has the function of increasing temperatures on which thermophysical properties of the glass composite are dependent, such as glass transition temperature and softening point, the SiO₂ content is preferably limited to suppress this function. Comparison between Examples 7 through 9 and Comparative Example 3 has shown that the SiO₂ content in the glass composite needs to be 70 mol % or less such that the glass transition temperature falls within the temperature range suitable for a process for manufacturing a fluorescent lamp.

### EMBODIMENT 3

An effect of the total content of SiO₂ and B₂O₃ in a phosphor adhesive glass composite of the present invention will be described hereinafter. FIG. 9 shows the compositions and evaluation results of phosphor adhesive glass composites of Examples 10 through 12 and Comparative Examples 4 and 5.

As obvious from FIG. 9, all of glass transition temperatures of Examples 10 through 12 fell within the temperature range suitable for a process for manufacturing a fluorescent lamp, and the values of coloration tests thereon exceeded 95. Thus, the glass composites of Examples 10 through 12 are effective for phosphor adhesion.

After rapidly cooled, both of the compositions of Comparative Examples 4 and 5 were devitrified into a crystalline state. Glass composites hardly cause softening in a crystalline state. Thus, the use of Comparative Example 4 or 5 as a phosphor adhesive glass composite may cause the spalling-away of a phosphor film in a fluorescent lamp.

Accordingly, the glass composite preferably contains at least one of SiO₂ and B₂O₃ as an essential component in order not to be devitrified and crystallized. Comparison between Examples 10 through 12 and Comparative Examples 4 and 5 has shown that in order to obtain an amorphous glass composite with stability, the total percentage of SiO₂ and B₂O₃ contained in the glass composite needs to be 20 mol % or more and preferably 25 mol % or more.

### EMBODIMENT 4

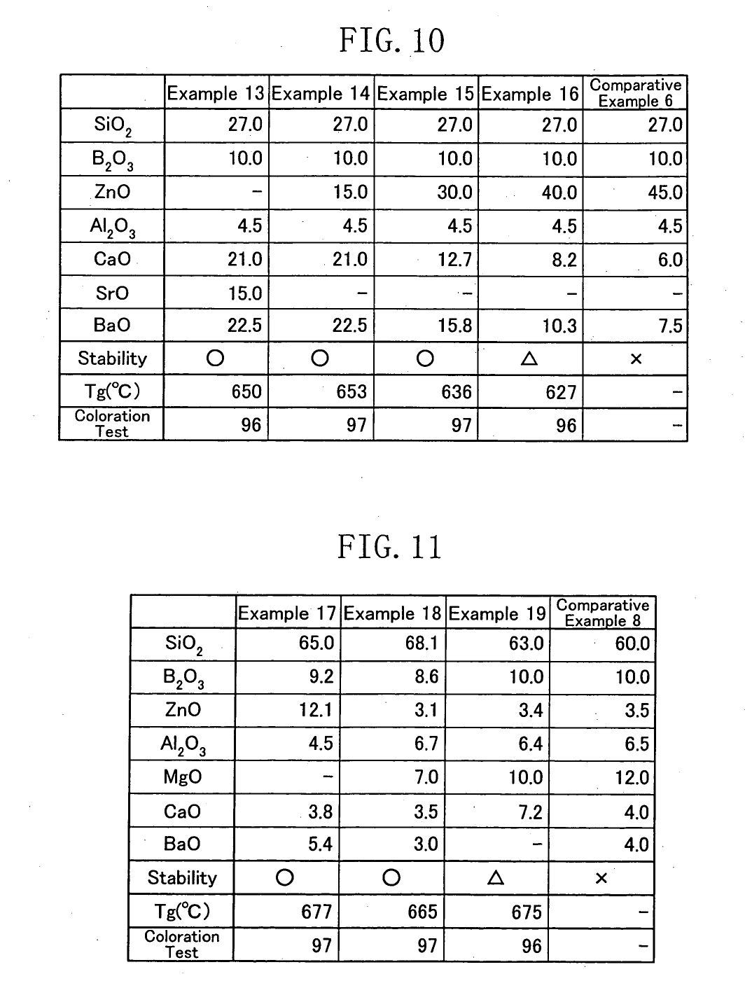

An effect of the ZnO content in a phosphor adhesive glass composite of the present invention will be described hereinafter. FIG. 10 shows the compositions and evaluation results of phosphor adhesive glass composites of Examples 13 through 16 and Comparative Example 6.

As obvious from FIG. 10, all of glass transition temperatures of Examples 13 through 16 fell within the temperature range suitable for a process for manufacturing a fluorescent lamp, and the values of coloration tests thereon exceeded 95. Thus, the glass composites of Examples 13 through 16 are effective for phosphor adhesion.

After rapidly cooled, the composition of Comparative Example 6 was devitrified into a crystalline state. Glass composites hardly cause softening in a crystalline state. Thus, the use of Comparative Example 6 as a phosphor adhesive glass composite may cause the spalling-away of a phosphor film in a fluorescent lamp.

ZnO contributes to the lowering of the glass melting point. Thus, in order to obtain a stable low-melting glass, it is preferably contained in the glass composite. However, an excessively large ZnO content does not provide a steady amorphous state. Comparison between Examples 13 through 16 and Comparative Example 6 has shown that in order to obtain an amorphous glass composite with stability, the ZnO content of the glass composite needs to be 40 mol % or less and preferably 30 mol % or less.

### EMBODIMENT 5

An effect of the MgO content of a phosphor adhesive glass composite of the present invention will be described hereinafter. FIG. 11 shows the compositions and evaluation results of phosphor adhesive glass composites of Examples 17 through 19 and Comparative Example 8.

As obvious from FIG. 11, all of glass transition temperatures of Examples 17 through 19 fell within the temperature range suitable for a process for manufacturing a fluorescent lamp, and the values of coloration tests thereon exceeded 95. Thus, the glass composites of Examples 17 through 19 are effective for phosphor adhesion.

After rapidly cooled, the composition of Comparative Example 8 was devitrified into a crystalline state. Glass composites hardly cause softening in a crystalline state. Thus, the use of Comparative Example 8 as a phosphor adhesive glass composite may cause the spalling-away of a phosphor film in a fluorescent lamp.

MgO has the function of promoting vitrification in a glass composite containing SiO₂ and B₂O₃. However, unless it is limited to a small amount, it may cause devitrification. Comparison between Examples 17 through 19 and Comparative Example 8 has shown that in order to obtain an amorphous glass composite with stability, the MgO content of the glass composite needs to be 10 mol % or less and preferably 7 mol % or less.

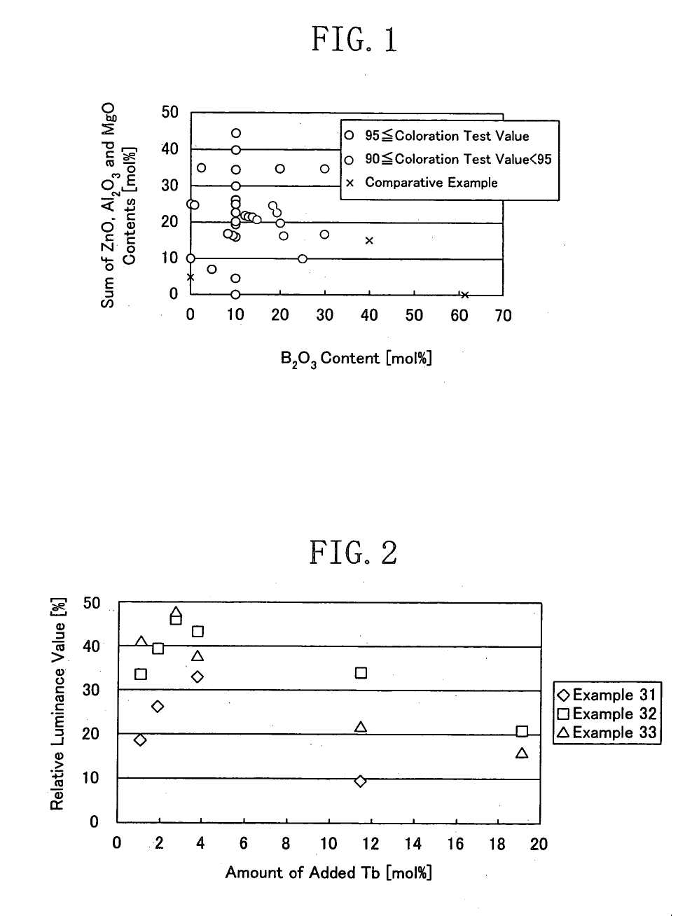

In addition, ZnO, Al₂O₃ and MgO, instead of B₂O₃, contribute to the lowering of the glass melting point and are components for obtaining a stable low-melting glass. Therefore, the smaller the B₂O₃ content, the larger the ZnO, Al₂O₃ and MgO contents need to be. As shown in FIG. 1, the sum of the B₂O₃, ZnO, Al₂O₃ and MgO contents is set at 10 mol % or more, thereby obtaining a low-melting and stable glass composite.

### EMBODIMENT 6

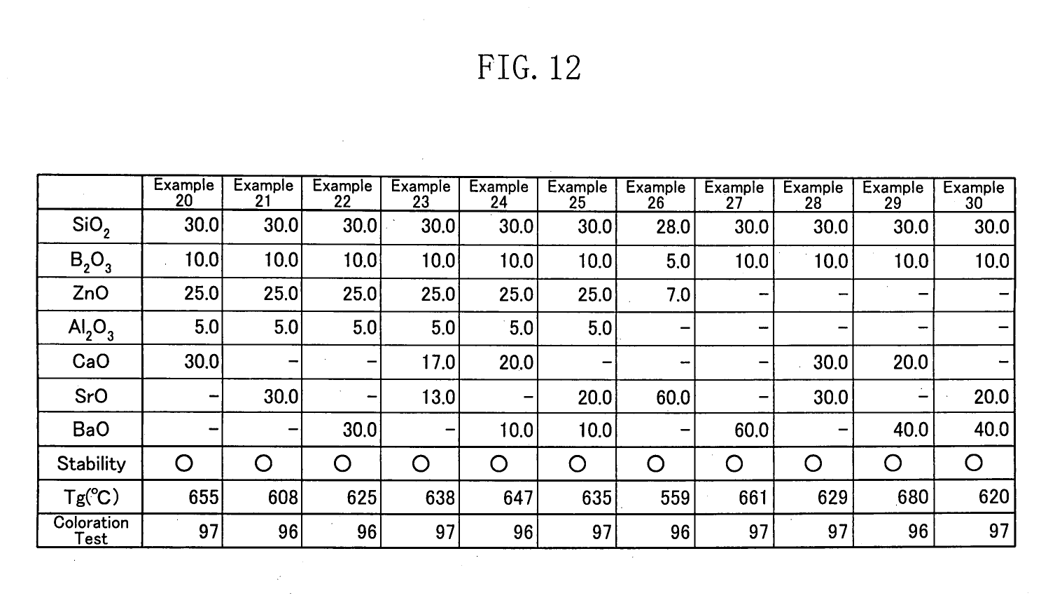

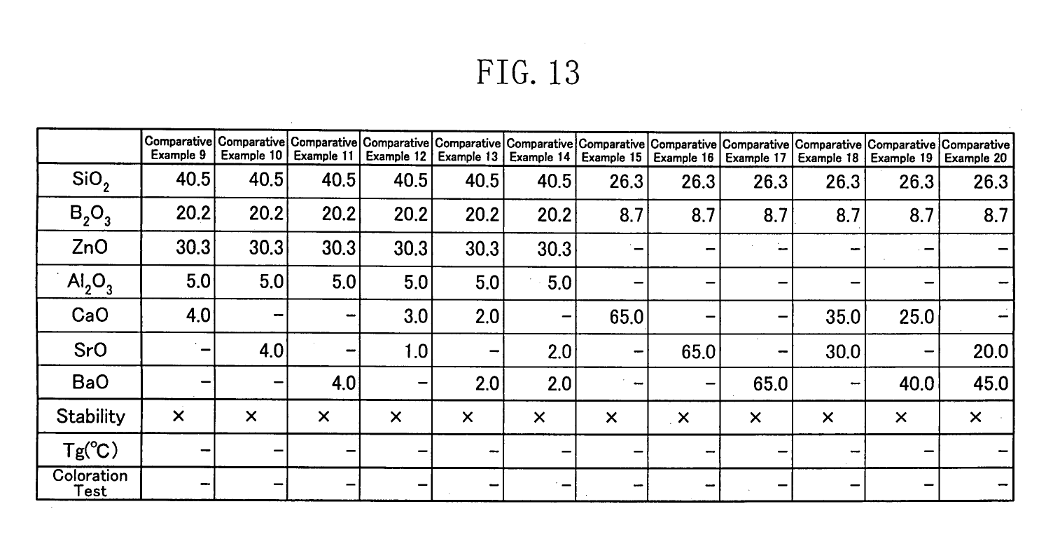

An effect of the CaO, SrO and BaO contents of a phosphor adhesive glass composite of the present invention will be described hereinafter. FIGS. 12 and 13 show compositions and evaluation results of phosphor adhesive glass composites of Examples 20 through 30 and Comparative Examples 9 through 20.

As obvious from FIG. 12, all of glass transition temperatures of Examples 20 through 30 fell within the temperature range suitable for a process for manufacturing a fluorescent lamp, and the values of coloration tests thereon exceeded 95. Thus, the glass composites of Examples 20 through 30 are effective for phosphor adhesion.

Furthermore, as obvious from FIG. 13, after rapidly cooled, all of the compositions of Comparative Examples 9 through 20 were devitrified into crystalline states. Glass composites hardly cause softening in crystalline states. Thus, the use of any of Comparative Examples 9 through 20 as a phosphor adhesive glass composite may cause the spalling-away of a phosphor film in a fluorescent lamp.

CaO, SrO and BaO have the function of promoting vitrification in a glass composite containing SiO₂ and B₂O₃ and furthermore SrO and BaO have the function of promoting the lowering of the glass melting point. Therefore, at least one of CaO, SrO and BaO is preferably contained therein as an essential component. However, excessively large contents of these materials do not provide a steady amorphous state. Comparison between Examples 17 through 19 and 20 through 30 and Comparative Examples 9 through 20 has shown that in order to obtain an amorphous glass composite with stability, the total content of at least one selected from the group consisting of CaO, SrO and BaO in the glass composite needs to be between 6.5 and 60 mol % both inclusive.

The phosphor adhesive glass composites of the first through sixth embodiments do not have luminescence resulting from ultraviolet radiation. Therefore, a phosphor film using each phosphor adhesive glass composite of these embodiments as an adhesive for a fluorescent lamp would contain a non-luminous material by the content of the adhesive for a fluorescent lamp. The present inventors planned that not only a phosphor but also an adhesive for a fluorescent lamp would be allowed to emit light to improve the luminous efficacy of the fluorescent lamp. For this purpose, various kinds of glass samples were prepared by adding lanthanoid or other different elements known as a luminescent center to each phosphor adhesive glass composite of these embodiments, and then subjected to an experiment to measure luminescence. As a result, it was found that red radiation is obtained by adding samarium or europium and green radiation by adding terbium (Tb³⁺). In order to improve the luminous efficacy of a fluorescent lamp, it is effective to add green radiation. Thus, the relationship between the terbium content and the luminescence intensity was quantitatively determined.

A glass sample added with terbium was prepared in the following manner. Oxide, and carbonate, oxalate, hydroxide and the like changed into oxide by heat treatment at 1000° C. or higher, which are materials of the phosphor adhesive glass composites of the first through sixth embodiments, were mixed at a stoichiometry that can provide a target composition and then mixed with terbia. The resultant mixture was put into a heat-resistant vessel such as an alumina crucible, melted by heating at temperatures at which the materials sufficiently melt (normally, 1200 through 1400° C.) and then cooled.

The glass transition temperature is given as one of parameters for controlling the behavior of an adhesive for a fluorescent lamp during a thermal process step, such as baking, tube bending and joining, in a manufacturing process for a circular fluorescent lamp, a U-tube, a multi-tube having a bridge structure, or other lamps. In phosphor adhesive glass composites of the present invention, the glass transition temperature is principally determined on the basis of the B₂O₃ content. Strictly speaking, phosphor adhesive glass composites of the first through sixth embodiments change their glass transition temperatures by adding terbium to them. However, the amount of added terbium falling within its range in which the luminous flux of each phosphor adhesive glass composite of these embodiments is substantially increased causes practically no big change in glass transition temperature as in the case of constituent elements other than B₂O₃.

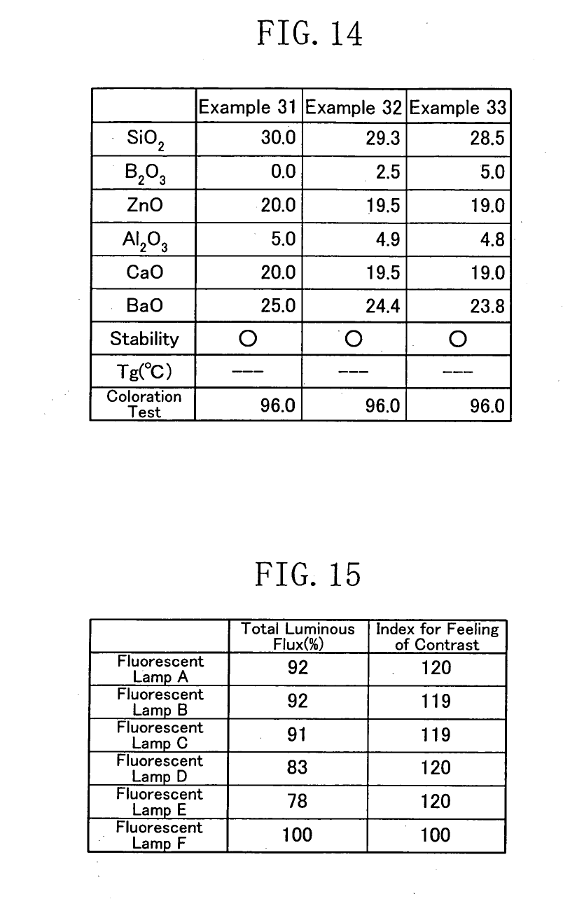

FIG. 14 shows compositions of phosphor adhesive glass composites of this embodiment having different B₂O₃ contents, used as samples for studying the effect caused by terbium addition. Example 31 shows the composition having a B₂O₃ content of zero and is the same as Example 1. The compositions having B₂O₃ contents of 2.5 mol % and 5 mol % are hereinafter referred to as Examples 32 and 33, respectively.

Glass composites were prepared by adding different amounts of terbium to Examples 31, 32 and 33, respectively. The glass composites were all completely amorphous within the studied range of the amount of added terbium (Tb³⁺). These terbium (Tb³⁺)-added glass composite samples were measured in relative value between the luminance of light emitted by the excitation of each sample resulting from 200 nm-through-400 nm ultraviolet radiation including 254 nm radiation and that of light emitted by a terbium-activated lanthanum phosphate phosphor. FIG. 2 shows the measurement results. Computational analyses based on luminous intensity data of phosphors has showed that the use of any of the phosphor adhesive glass composites of this embodiment as an adhesive for a three band daylight fluorescent lamp provides significant luminous flux increase as compared with the use of a known adhesive, at a relative luminance value of 20% or more, and can be expected to provide further practically desirable increase in luminous flux at a relative luminance value of 40% or more. As seen from FIG. 2, for Example 31, the range of terbium (Tb³⁺) contents having a relative luminance value of 20% or more is between 1.0 mol % and 4.0 mol % both inclusive. For Example 32, the range of terbium (Tb³⁺) contents having a relative luminance value of 20% or more is between 1.0 mol % and 20 mol % both inclusive. For Example 33, the range of terbium (Tb³⁺) contents having a relative luminance value of 20% or more is between 1.0 mol % and 12 mol % both inclusive. Therefore, the rate of increase in luminous flux depends on the composition of the phosphor adhesive glass composite of this embodiment. However, a relative luminance value of 20% or more can be obtained within the range of terbium (Tb³⁺) contents of 20 mol % and less. It is desirable that a relative luminance value of 40% or more is obtained, and in this case the terbium (Tb³⁺) content is between 1.0 mol % and 4.0 mol % both inclusive.

### EMBODIMENT 7

A description will be given below of fluorescent lamps according to an embodiment using the above-studied, various glass composites and europium-activated yttrium oxysulfide phosphor as a red phosphor.

A 30 W circular fluorescent lamp A (hereinafter, referred to as a fluorescent lamp A) with a correlated color temperature of 7200K and a DUV of −3 was manufactured in the following manner. A soda lime glass bulb or tube was coated with a slurry containing europium-activated yttrium oxysulfide phosphor, europium-activated barium magnesium aluminate phosphor (hereinafter, referred to as a blue phosphor), cerium-terbium coactivated lanthanum phosphate phosphor (hereinafter, referred to as a green phosphor), and the phosphor adhesive glass composite of Example 1 of 3% by weight relative to the gross weight of the phosphors to form a phosphor layer by drying and baking. Thereafter, the glass tube was heated with nitrogen encapsulated therein and then bent.

Likewise, 30 W circular fluorescent lamps B and C (hereinafter, referred to as fluorescent lamps B and C) were manufactured using europium-activated yttrium oxysulfide phosphor, a blue phosphor, a green phosphor, and the glass composite of Example 2 only for the fluorescent lamp B and the glass composite of Example 3 only for the fluorescent lamp C.

Furthermore, 30 W circular fluorescent lamps D and E (hereinafter, referred to as fluorescent lamps D and E) were manufactured using europium-activated yttrium oxysulfide phosphor, a blue phosphor, a green phosphor, and the glass composite of Comparative Example 1 only for the fluorescent lamp D and the glass composite of Comparative Example 2 only for the fluorescent lamp E.

Moreover, a 30 W circular fluorescent lamp F (hereinafter, referred to as a fluorescent lamp F) was manufactured using, as a red phosphor, europium-activated yttrium oxide phosphor commonly used for a fluorescent lamp instead of europium-activated yttrium oxysulfide phosphor and, as a phosphor adhesive glass composite, a commonly used BaO.CaO.B₂O₃ glass composite as shown in Comparative Example 2.

FIG. 15 shows the total luminous fluxes and indices for feeling of contrast of the fluorescent lamps A through E at their initial burning time. The total luminous fluxes are represented by values relative to the fluorescent lamp F.

As seen from FIG. 15, the initial total luminous fluxes of the fluorescent lamps A through E depend on the B₂O₃ contents of the associated glass composites and decrease with increased B₂O₃ contents. The reason for this is that the effect of the present invention described in the first embodiment can suppress the coloration of the glass composite in a process for manufacturing a lamp. Furthermore, the indices for feeling of contrast of the fluorescent lamps A through E are about 1.2 times as high as that of the fluorescent lamp F.

The fluorescent lamps A through E are lower in the initial total luminous flux than the fluorescent lamp F due to their different emission wavelengths of red phosphors. However, the brightness sensation obtained from chromatic objects under an illumination light source is proportional to the product of the index for feeling of contrast and the total luminous flux. More particularly, like the fluorescent lamps A through C, when the lamp has an index-for-feeling-of-contrast ratio of about 1.2 and a total luminous flux ratio of larger than 0.85 with respect to the fluorescent lamp F, its brightness sensation is about 1.05 or more times as high as that of the fluorescent lamp F. When the lamp has a total luminous flux of larger than 0.90, its brightness sensation is about 1.10 or more times as high as that of the fluorescent lamp F. In these cases, it can be recognized that the brightness sensation obtained from chromatic objects is enhanced. However, like the fluorescent lamps D and E, when the index-for-feeling-of-contrast ratio is large but the total luminous flux ratio is smaller than 0.85, the brightness sensation inversely becomes lower than that of the fluorescent lamp F. Thus, in these cases, the brightness sensation obtained from chromatic objects cannot be expected to be enhanced. Therefore, a phosphor adhesive glass composite falling within the composition range described in the first through sixth embodiments needs to be employed to constitute a three-band circular fluorescent lamp that can be expected to have a higher brightness sensation than known fluorescent lamps by using oxysulfide as a red phosphor.

Furthermore, the phosphor adhesive glass composite falling within the composition range described in the first through sixth embodiments has the effect of reducing a chromaticity shift of a fluorescent lamp combined with any of commonly used phosphors and oxysulfide phosphors.

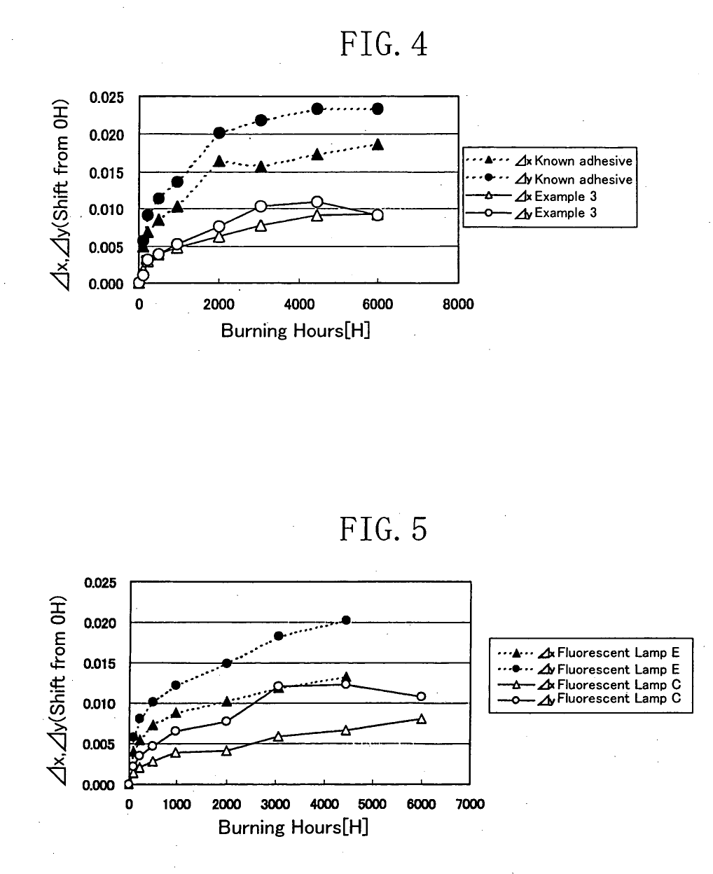

FIG. 4 is a graph showing the relationship between burning hours and chromaticity shift (shifts Δx and Δy from lamp start in CIE 1931 chromaticity diagram) for circular fluorescent lamps with a correlated color temperature of 7200K and a DUV of −3 in which europium-activated yttrium oxide, terbium-activated lanthanum phosphate and europium-activated barium aluminate are combined. Black symbols (Δ, ∘) represent characteristics concerning a fluorescent lamp using, as an adhesive, a known adhesive obtained by mixing 60% low-melting glass of a BaO.CaO.B₂O₃ composition with 40% calcium pyrophosphate (hereinafter, referred to as a known fluorescent lamp). Outline symbols (Δ, ∘) represent characteristics concerning a fluorescent lamp using, as an adhesive, a glass composite of Example 3 (hereinafter, referred to as an example fluorescent lamp).

As shown in FIG. 4, the amount of chromaticity shift relative to the burning hours in the example fluorescent lamp is half or less as large as the known fluorescent lamp. In comparison of electrical and phosphor luminous characteristics between 6000 hours and 100 hours in burning hours, no difference was found for either of the example fluorescent lamp and the known fluorescent lamp. However, the fluorescent lamp at 100 hours of burning hours had a white appearance, while the fluorescent lamp at 6000 hours of burning hours exhibited coloration. This coloration after long-time burning was brown for the known fluorescent lamp, while it was light gray for the example fluorescent lamp.

Illumination light emitted by each fluorescent lamp changes with burning hours to increase redness, because the signs of the chromaticity shifts (Δx, Δy) shown in FIG. 4 are both positive. This change leads to the problem that in spite of a fluorescent lamp having a high correlated color temperature on purchase, it shifts to lower correlated color temperatures with increased burning hours, resulting in a change in the lighting environment.

In this case, the color of the known fluorescent lamp shifts to increase redness. On the other hand, the color of the example fluorescent lamp shifts to insignificantly increase redness and its shifted color is close to an achromatic color. This shows that a difference in chromaticity shift is caused by a difference in coloration after long-time burning between fluorescent lamps. A material causing such coloration can be estimated to be mercury. Therefore, the color difference between black symbols and outline symbols in FIG. 4 is believed to be due to difference between the forms of mercury encapsulated in the fluorescent lamp tubes or bulbs. That is, since elemental mercury is black and mercuric oxide is red, it can be considered that such a color difference exhibits a difference in coloration between the fluorescent lamps. Therefore, it is considered that in the known fluorescent lamp, boric acid contained in the adhesive oxidizes mercury to produce mercuric oxide, while in the example fluorescent lamp, a relatively large amount of elemental mercury exists because of a small boric acid content of the adhesive.

Therefore, in order to reduce a chromaticity shift resulting from long-time burning, it is effective to decrease the amount of generated mercuric oxide. To cope with this, the boric acid content of a glass composite used as an adhesive needs to be reduced. The strength of an oxidative reaction caused by boric acid contained in a glass composite depends on the boric acid content per unit weight of the glass composite. For the known adhesive, the B₂O₃ content per unit weight of the glass composite is 28%. It is considered that in order to reduce a chromaticity shift resulting from long-time burning, the boric acid content needs to be less than 28%. To be specific, it was determined that a boric acid content of 25.2%, equivalent to nine-tenths of 28%, or less could be fully expected to provide the effect of chromaticity shift reduction.

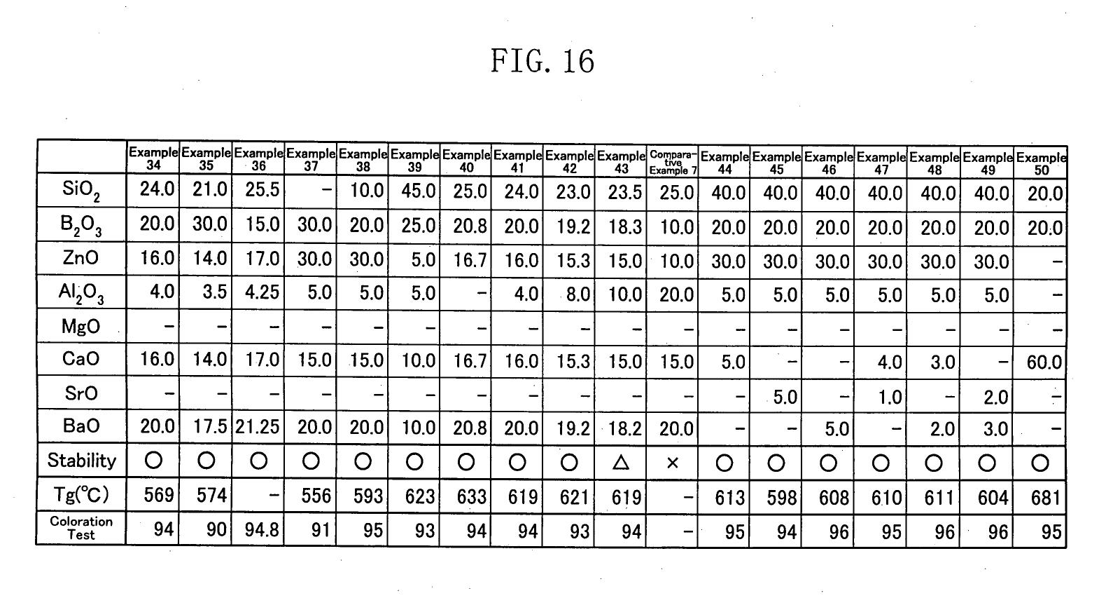

Example 35 of FIG. 16 corresponds to the upper limit of boric acid contents allowing for chromaticity shift reduction. In Example 35, the B₂O₃ content per unit weight of the glass composite is 25% and the B₂O₃ molar content is 30 mol %. For reference's sake, in Example 3 shown in FIG. 4, the B₂O₃ content per unit weight of the glass composite is 8%.

Thus, as shown in Example 35, the upper limit of B₂O₃ contents achieving the prevention of initial coloration is approximately equal to that achieving the prevention of chromaticity shift. A cause for this is that B₂O₃ has the property of taking electrons, i.e., oxidation. The initial coloration is caused because B₂O₃ takes electrons from S²⁻ of Y₂O₂S so that S²⁻ turns into an S atom to diffuse into the glass composite. On the other hand, the chromaticity shift is caused because electrons of Hg are taken by B₂O₃ during long-time burning to turn into Hg²⁺ exhibiting brown coloration and the resultant Hg²⁺ adheres to the glass composite or phosphor.

Next, FIG. 5 is a graph showing the relationship between burning hours and chromaticity shifts Δx and Δy from the start (burning hours=0 H) for circular fluorescent lamps with a correlated color temperature of 7200K and a DUV of −3 in which europium-activated yttrium oxysulfide, terbium-activated lanthanum phosphate and europium-activated barium aluminate are combined. Black symbols (Δ, ∘) represent characteristics concerning the known fluorescent lamp. Outline symbols (Δ, ∘) represent characteristics concerning the example fluorescent lamp. As seen from FIG. 5, the amount of chromaticity shift relative to the burning hours in the example fluorescent lamp is half or less as large as that in the known fluorescent lamp. Like the above-described case, the reason for this phenomenon is also that the boric acid content is small in Example 3.

As can be seen from the above, the fluorescent lamp using the glass composite of this embodiment as an adhesive exhibits a chromaticity shift from the start by approximately half as large in chromaticity coordinate as the fluorescent lamp using the known glass composite as an adhesive.

Furthermore, as seen from FIG. 5 in which the fluorescent lamps C and E are compared to each other, the fluorescent lamp using an oxysulfide phosphor also has the effect of chromaticity shift reduction.

In the first through sixth embodiments, each glass composite was described to have a composition in which the sum of the molar percentages of SiO₂, B₂O₃, ZnO, Al₂O₃, MgO, CaO, SrO, and BaO is 100. However, the other substances including, for example, Sc₂O₃, Y₂O₃, La₂O₃, other lanthanoid oxides, ZrO₂, TiO₂, and HfO₂ may be contained in amounts (trace amounts) providing the above-described effects of coloration reduction and chromaticity shift reduction.

### EMBODIMENT 8

A description will be given below of fluorescent lamps according to an embodiment using glass composites of different compositions varied from those in the seventh embodiment and europium-activated yttrium oxysulfide phosphor as a red phosphor.

FIG. 16 shows the compositions of phosphor adhesive glass composites of this embodiment.

Fluorescent lamps were manufactured using, as phosphor adhesive glass composites, glass composites of examples shown in FIG. 16 in the same manner as the fluorescent lamp A of the seventh embodiment. Out of these lamps, a fluorescent lamp X using a glass composite of Example 34, for example, had 90% of the total luminous flux of the fluorescent lamp F and a 120 index for feeling of contrast both at its initial burning time. A fluorescent lamp Y using a glass composite of Example 35 had 88% of the total luminous flux of the fluorescent lamp F and a 119 index for feeling of contrast both at its initial burning time.

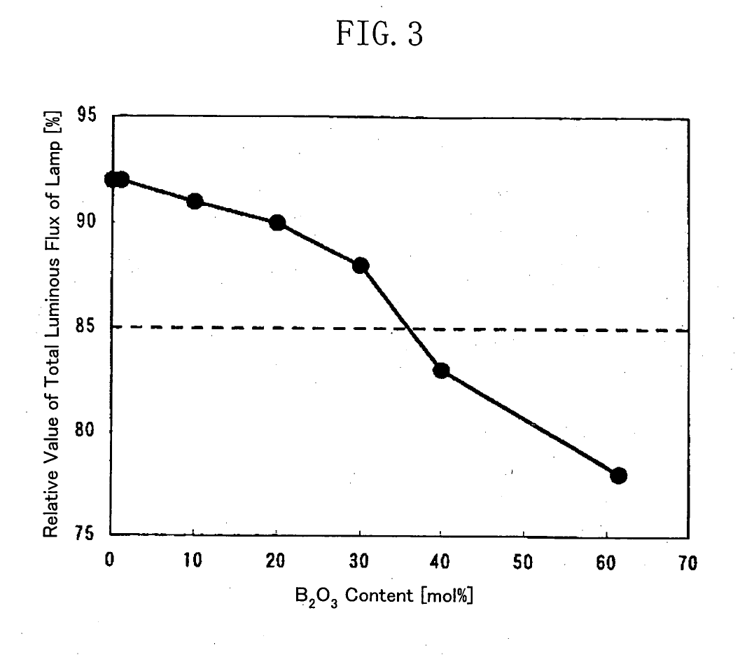

FIG. 3 is a graph showing how the total luminous flux (hereinafter referred to as the relative lamp total luminous flux) of each of the fluorescent lamps A through E of the seventh embodiment and the fluorescent lamps X and Y of this embodiment at the initial burning time changes depending on the B₂O₃ content. When the B₂O₃ content is 30 mol % or less, the relative lamp total luminous flux is 88% or more. In this case, the index for feeling of contrast is about 120. Therefore, the brightness sensation becomes about 1.08 or more times as high as that of the fluorescent lamp F so that the brightness sensation obtained from chromatic objects can be recognized to be enhanced. Examples 36 through 50 also have a B₂O₃ content between 15 mol % and 30 mol % both inclusive and a 120 index for feeling of contrast. Thus, the brightness sensation can be recognized to be enhanced likewise.

Also in this embodiment, the fluorescent lamps using these glass composites as adhesives each exhibit a chromaticity shift from the start by approximately half as large in chromaticity coordinate as the fluorescent lamp using the known glass composite as an adhesive. The fluorescent lamp using an oxysulfide phosphor also has the effect of chromaticity shift reduction.

As shown in FIG. 16, the phosphor adhesive glass composites of Examples 34 through 50 of this embodiment have a sufficient stability and also a glass transition temperature falling within the temperature range suitable for a process for manufacturing a fluorescent lamp. Furthermore, in Examples 38, 44, and 46 through 50, the values of coloration tests are 95 or greater and therefore the effect of preventing the luminous flux from decreasing is large. Also in the other examples, the values of coloration tests are 90 or greater. Thus, it can be said that the effect of preventing the luminous flux from decreasing is practically enough. On the other hand, in Comparative Example 7, a glass composite was devitrified into a crystalline state after rapidly cooled during the manufacturing thereof. Therefore, it cannot be used as a phosphor adhesive glass composite.

The phosphor adhesive glass composites of Examples 34 through 50 of this embodiment each have a SiO₂ content between 0 mol % and 70 mol % both inclusive, a B₂O₃ content between 15 mol % and 30 mol % both inclusive, the sum of SiO₂ and B₂O₃ contents of 20 mol % or more, and the sum of CaO, SrO and BaO contents between 5 mol % and 60 mol % both inclusive. Therefore, fluorescent lamps using these phosphor adhesive glass composites can prevent the luminous flux from decreasing and enhance the brightness sensation without causing the phosphor film to spall away in a process for manufacturing a fluorescent lamp.

Next, an effect of the Al₂O₃ content will be described by comparing the third embodiment with Comparative Example 7 of this embodiment.

Al₂O₃ has the effect of promoting vitrification and therefore it should preferably be contained in a glass composite. However, unless it is limited to a small amount, stable vitrification is prevented. Comparison between Examples 10 through 12 and Comparative Example 7 has shown that in order to obtain an amorphous glass composite with stability, the Al₂O₃ content of the glass composite needs to be 10 mol % or less and preferably 8 mol % or less.

The shapes of the fluorescent lamps of the seventh and eighth embodiments are not restricted to a circular shape requiring a process step for bending a glass tube. The fluorescent lamps can be applied to various bulbs and tubes of a straight shape, a U-shape, a W-shape, and other shapes. In any case, the luminous efficacy of the oxysulfide phosphor can be restrained from decreasing due to a thermal load exceeding the softening point of soda lime glass. In this embodiment, a fluorescent lamp using a low-pressure mercury discharge was exemplified as a fluorescent device. However, examples of applicable fluorescent devices include a plasma display, a fluorescent bulb or tube for display, and a fluorescent lamp using a rare gas discharge. These devices can also reduce the chromaticity shift of the phosphor film when used. In particular, the coloration of an oxysulfide phosphor film in a manufacturing process can be prevented. Since fluorescent lamps with other color temperatures and DUVs can also use oxysulfide phosphors, they can be expected to have the similar effect of improving the index for feeling of contrast. In addition, the use of the phosphor adhesive glass composites described in the first through eighth embodiments can be expected to restrain luminous characteristics of the phosphor films from deteriorating in a process for manufacturing a fluorescent lamp. As a result, the practical total luminous flux can be obtained.

Furthermore, combinations of other blue phosphors and green phosphors also provide the similar effects of improving the index for feeling of contrast and restraining the phosphor film from deteriorating in a process for manufacturing a lamp. For example, europium-activated barium, calcium, strontium, and magnesium halphosphate phosphor can be used as a blue phosphor, and cerium-terbium coactivated magnesium aluminate phosphor as a green phosphor.

The combinations of the plurality of phosphors in this embodiment are not restrictive. Fluorescent lamps containing the phosphor adhesive glass composites described in the first through eighth embodiments can restrain the phosphor film from deteriorating and spalling away in a manufacturing process and provide improved initial total luminous flux and reduced chromaticity shift.

The glass composites used for phosphor adhesion described in the first through eighth embodiments have a small boric acid content. Thus, they are not colored by exerting an oxidizing action on nearby substances or taking the substances therein. Hence, the use of the glass composites is not limited to phosphor adhesion in a fluorescent device but these glass composites are typically effective also for joining different kinds of glasses together or glass and metal. For example, also in a fluorescent device, these glass composites are used not only for phosphor adhesion but also for the sealing of an evacuated envelope encapsulating various kinds of substances and the bonding of electrodes. This can prevent the envelope, the encapsulated substances and the electrodes from being oxidized. As a result, electrical and optical characteristics of the device can be kept for a long time.

As described above, phosphor adhesive glass composites of the present invention are expressed by xSiO₂.yB₂O₃.aZnO.bAl₂O₃.cMgO.mXO, where X is at least one element selected from the group consisting of Ca, Sr and Ba, 5≦x≦70 mol %, 0≦y≦30 mol %, x+y≧20 mol %, and 5≦m≦60 mol %. This can restrain the spalling-away of a phosphor film from a fluorescent bulb or tube, suppress coloration and chromaticity shift of the phosphor adhesive glass composite in a process for manufacturing a light emitting device and improve the initial luminous flux of a fluorescent device.

What is claimed is:

1. A fluorescent device comprising a phosphor adhesive glass composite and a phosphor,
wherein the phosphor adhesive glass composite is expressed by xSiO₂.yB₂O₃.aZnO.bAl₂O₃.cMgO.mXO where X is at least one element selected from the group consisting of Ca, Sr and Ba, 5≦x≦70 mol %, 0≦y≦30 mol %, x+y≧20 mol %, 5≦m≦60 mol %, a≦40 mol %, b≦10 mol %, c≦10 mol %, and a+b+c≧10 mol %.

2. The fluorescent device of claim 1, wherein the phosphor is an oxysulfide phosphor.

3. The fluorescent device of claim 2, wherein 0≦y≦15 mol % and 6.5≦m≦60 mol %.

4. The fluorescent device of claim 2, wherein the oxysulfide phosphor is europium activated yttrium oxysulfide phosphor.

5. The fluorescent device of claim 1, wherein the fluorescent device further contains Tb³⁺ and 1≦Tb³⁺≦4 mol %.

6. A fluorescent lamp comprising a phosphor adhesive glass composite and a phosphor,
wherein the phosphor adhesive glass composite is expressed by xSiO₂.yB₂O₃.aZnO.bAl₂O₃.cMgO.mXO where X is at least one element selected from the group consisting of Ca, Sr and Ba, 5≦x≦70 mol %, 0≦y≦30 mol %, x+y≧20 mol %, 5≦m≦60 mol %, a≦40 mol %, b≦10 mol %, c≦10 mol %, and a+b+c≧10 mol %,
the phosphor is an oxysulfide phosphor, and
a discharge path is nonlinear.

7. The fluorescent lamp of claim 6, wherein 0≦y≦15 mol % and 6.5≦m≦60 mol %.

8. The fluorescent lamp of claim 6, wherein the oxysulfide phosphor is europium activated yttrium oxysulfide phosphor.

9. A glass composite, wherein
the glass composite is expressed by XSiO₂.yB₂O₃.aZnO.bAl₂O₃.cMgO.mXO where X is at least one element selected from the group consisting of Ca, Sr and Ba, 5≦x≦70 mol %, 0≦y≦30 mol %, x+y≧20 mol %, 5≦m≦60 mol %, a≦40 mol %, b≦10 mol %, c≦10 mol %, and a+b+c≧10 mol %.
